(19) United States
(12) Patent Application Publication
(10) Pub. No.: US 2020/0004691 A1
(43) Pub. Date: Jan. 2, 2020

(54) Systems and Methods for Managing Dynamic Random Access Memory (DRAM)

(71) Applicant: Huawei Technologies Co., Ltd., Shenzhen (CN)

(72) Inventor: Jani Kokkonen, Munich (DE)

(21) Appl. No.: 16/570,700

(22) Filed: Sep. 13, 2019

Related U.S. Application Data
(63) Continuation of application No. PCT/EP2017/055959, filed on Mar. 14, 2017.

(51) Int. Cl. G06F 12/1036; G06F 12/109; G06F 9/455; G06F 13/16

(52) U.S. Cl. CPC G06F 12/1036; G06F 12/109; G06F 9/45545; G06F 2212/657; G06F 13/1668; G06F 2009/45583; G06F 2212/152; G06F 9/45558

(57) ABSTRACT

An apparatus for managing a dynamic random access memory (DRAM) includes a processor configured to map a plurality of clusters of banks of the DRAM to a plurality of applications executing on a common virtual machine (VM), where the common VM runs on a host operating system (OS) of a host computing device, and where each of the clusters of banks is used exclusively by each mapped application.

### CROSS-REFERENCE TO RELATED APPLICATIONS

This application is a continuation application of International Patent Application No. PCT/EP2017/055959 filed on Mar. 14, 2017, which is hereby incorporated by reference in its entirety.

### TECHNICAL FIELD

The present disclosure, in some embodiments thereof, relates to DRAM and, in particular, to methods and systems for managing DRAM.

### BACKGROUND

In modern memory systems the access to DRAM is controlled by the memory controller. DRAM is divided into a hierarchy of channel, bank, rank, row, and column in order to improve throughput and performance. The memory controller uses a specified subset of bits of a physical address to select the channel, rank, bank, row, and column. The memory algorithm used in memory controllers is typically configured by system firmware and is therefore tedious to change. Hardware capabilities of the memory controller also set limits on possible implementation options.

### SUMMARY

It is an object of the present disclosure to provide an apparatus, a method, a computer program product, and a system for managing DRAM.

The foregoing and other objects are achieved by the features of the independent claims. Further implementation forms are apparent from the dependent claims, the description and the figures.

According to a first aspect, an apparatus for managing DRAM is provided, the apparatus comprising a processor configured to map each cluster of a plurality of clusters of banks of the DRAM, to each application of a plurality of applications executing on a common virtual machine (VM) running on a host operating system (OS) of a host computing device, wherein each cluster of banks is used exclusively by each mapped application.

In a first possible implementation of the apparatus according to the first aspect, the processor is configured to execute a hypervisor that runs the common VM, wherein the hypervisor is configured to perform the mapping of each cluster of the plurality of clusters of banks of the DRAM by translating the mapping of each cluster of the plurality of clusters of the DRAM to physical addresses that are provided to a memory controller controlling the DRAM.

The mapping is performed using software, which provides for integration with an existing memory controller implemented in hardware. Mapping using software provides for rapid and easy deployment in existing computing devices.

According to a second aspect, a method of managing DRAM is provided, the method comprising mapping each cluster of a plurality of clusters of banks of the DRAM, to each application of a plurality of applications executing on a common VM running on a host OS of a host computing device, wherein each cluster of banks is used exclusively by each mapped application.

The apparatus according to the first aspect, and/or the method according to the second aspect described herein address the technical problem of avoiding or reducing contention in memory banks of the DRAM, in particular, for applications executing on a common VM. Each application executing on the common VM is mapped to a cluster of banks designated for exclusive use by the mapped application, in comparison, for example, to Bank-level Partition Mechanism (BPM) method that consider the common VM as a single executing application. Methods such as BPM assign banks of DRAM to the common VM without consideration of the individual application executing on the common VM, which may lead to contention by the applications running on the common VM.

The computational performance improvements arise from reducing or preventing memory contention, and/or reducing or preventing memory controller swaps which is a computationally costly operation.

The computational performance improvement is obtained in the host OS side and/or the guest OS side.

In a first possible implementation of the method according to the second aspect, the mapping comprises mapping guest physical addresses used by a hypervisor hosting the common VM to physical addresses of the DRAM controlled by a memory controller.

The mapping is performed using software, which provides for integration with an existing memory controller implemented in hardware. Mapping using software provides for rapid and easy deployment in existing computing devices.

In a second possible implementation form of the apparatus according to the preceding first implementation form of the first or second aspects, the hypervisor is configured to map guest physical addresses used by the hypervisor to physical addresses of the DRAM controlled by the memory controller.

In a third possible implementation form of the apparatus according to the first aspect as such or the method according to the second aspect as such, or according to any of the preceding forms of the first or second aspects, the processor is further configured to or the method further comprises allocate another group of clusters of the plurality of clusters of banks of the DRAM to a second VM running on the host OS of the host computing device, wherein the second VM maps each member of the group of clusters to each application of a plurality of applications executing on the second VM, wherein each member of the group of clusters defines banks of the DRAM for exclusive use by each mapped application executing on the second VM.

Each VM may independently perform mapping of its assigned clusters to the applications running on the respective VM, which improves overall memory performance and/or computational performance.

In a fourth possible implementation form of the apparatus according to the first aspect as such or the method according to the second aspect as such, or according to any of the preceding forms of the first or second aspects, the processor is further configured to or the method further comprises uniquely map clusters of banks of the DRAM to each application of a plurality of applications executing on each VM of a plurality of VM running on the host OS of the host computing device, wherein each application executing on each VM of the plurality of VM has exclusive use of the mapped cluster.

The unique assignment of clusters to each application of each VM prevents or reduces memory contention between applications of the same VM and applications of different VM.

In a fifth possible implementation form of the apparatus according to the first aspect as such or the method according to the second aspect as such, or according to any of the preceding forms of the first or second aspects, the processor is further configured to or the method further comprises map clusters of banks to applications of the VM according to a scheduling policy.

The scheduling policy may be selected for the computational environment to further improve computational performance.

In a sixth possible implementation form of the apparatus according to the first aspect as such or the method according to the second aspect as such, or according to any of the preceding forms of the first or second aspects, the processor is further configured to or the method further comprises select the same location of bits indicative of the clusters of banks from the guest physical addresses used by the common VM that are used by the host OS from the actual physical addresses.

In a seventh possible implementation form of the apparatus according to the first aspect as such or the method according to the second aspect as such, or according to any of the preceding forms of the first or second aspects, the processor is further configured to or the method further comprises detect, by the host OS, a virtual memory page fault associated with a certain application of the plurality of applications executing on the common VM, identify the cluster of banks mapped to the certain application, and allocate at least one additional physical memory page to the certain application from the mapped cluster of banks.

Clusters selected at the VM side are enforceable at the hypervisor side. Cluster selection is performed at the VM side using clusters assigned to the application, which allows the hypervisor side to figure out the desired cluster from the faulting guest physical address and associated cluster bits.

In an eighth possible implementation form of the apparatus or the method according to the preceding seventh forms of the first or second aspects, the processor is further configured to or the method further comprises allocate at least one additional virtual memory page to the certain application from one of a plurality of default clusters of banks allocated to the common VM when an invalid cluster of banks is identified as mapped to the certain application.

In a ninth possible implementation form of the apparatus or the method according to the preceding seventh or eighth forms of the first or second aspects, the cluster of banks mapped to the certain application is identified by checking the bits indicative of the cluster of banks in the guest physical address.

The bits of the guest physical address may be accessed by the hypervisor to determine the guest physical address and associated cluster.

In a tenth possible implementation form of the apparatus or the method according to the preceding seventh or eighth forms of the first or second aspects, the cluster of banks mapped to the certain application is identified by checking at least one of hyp prefetch fault address register (HPFAR) register, a control register (CR), such as, CR2 register, and CR3 register.

The bits of the registers may be accessed by the hypervisor to determine the guest physical address and associated cluster.

In an eleventh possible implementation form of the apparatus according to the first aspect as such or the method according to the second aspect as such, or according to any of the preceding forms of the first or second aspects, at least one application of the plurality of applications is mapped to a plurality of clusters of banks of the DRAM, wherein the plurality of clusters of banks are used exclusively by the mapped at least one application.

Applications requiring a large amount of memory may be mapped to two or more clusters, for example, rather than mapping to a single cluster, which improves computational performance by providing the application with sufficient memory rather than experiencing errors due to insufficient memory.

Unless otherwise defined, all technical and/or scientific terms used herein have the same meaning as commonly understood by one of ordinary skill in the art to which the disclosure pertains. Although methods and materials similar or equivalent to those described herein can be used in the practice or testing of embodiments of the disclosure, exemplary methods and/or materials are described below. In case of conflict, the patent specification, including definitions, will control. In addition, the materials, methods, and examples are illustrative only and are not intended to be necessarily limiting.

### BRIEF DESCRIPTION OF THE DRAWINGS

Some embodiments of the disclosure are herein described, by way of example only, with reference to the accompanying drawings. With specific reference now to the drawings in detail, it is stressed that the particulars shown are by way of example and for purposes of illustrative discussion of embodiments of the disclosure. In this regard, the description taken with the drawings makes apparent to those skilled in the art how embodiments of the disclosure may be practiced.

FIG. 1 is a schematic of dataflow in a computing system implementing the BPM method while running two applications on a common VM to help in understanding the addressed technical problem, in accordance with some embodiments of the present disclosure;

FIG. 2 is a schematic depicting an example of selection of bank bits by a memory controller to help in understanding the addressed technical problem, in accordance with some embodiments of the present disclosure;

FIG. 3 is a schematic depicting allocation of DRAM banks to applications by the BPM method to help understand the addressed technical problem, in accordance with some embodiments of the present disclosure;

FIG. 4 is a flowchart of a method that manages DRAM by mapping clusters of banks of the DRAM to each application executing on a VM, in accordance with some embodiments of the present disclosure;

FIG. 5 is a block diagram of a system that includes an apparatus implemented as a computing device that stores cluster mapping code that communicates with a memory controller to manage DRAM, in accordance with some embodiments of the present disclosure;

FIG. 6 is a schematic depicting the described Qemu/KVM command line options, in accordance with some embodiments of the present disclosure;

FIG. 7 is a flowchart depicting page fault handing using other methods that do not consider applications executing on a VM to help understand implementations of the present disclosure;

FIG. 8 is a flowchart depicting page fault handling by a computing device, which takes into account applications running on VMs, in accordance with some embodiments of the present disclosure; and

FIG. 9 is a schematic depicting an exemplary mapping between guest virtual addresses and physical addresses during a LINUX kernel booting phase, in accordance with some embodiments of the present disclosure; and

FIG. 10 is a schematic depicting an exemplary mapping between guest virtual addresses of a guest virtual address page and physical addresses during an application launch phase, in accordance with some embodiments of the present disclosure.

### DETAILED DESCRIPTION OF EMBODIMENTS

The present disclosure, in some embodiments thereof, relates to DRAM and, in particular, to methods and systems for managing DRAM.

An aspect of some embodiments of the present disclosure relate to a system, and apparatus, and a method that maps clusters of banks of the DRAM to applications executing on a common VM running on a host OS of a host computing device. Each cluster of banks is used exclusively by each mapped application.

A hypervisor that runs the common VM performs the mapping of the clusters of banks of the DRAM, by translating the mapping of each cluster to physical addresses that are provided to a memory controller controlling the DRAM. The hypervisor maps guest physical addresses used by the VM to physical addresses of the DRAM controlled by the memory controller.

When multiple VMs are running on the host OS of the host computing device, one or more clusters of banks of the DRAM are mapped to each application executing on each VM. Each application executing on each VM has exclusive use of the mapped cluster.

The apparatus, system, and/or methods (e.g., code instructions stored in a data storage device executed by one or more processors) described herein address the technical problem of avoiding or reducing contention in memory banks of the DRAM, in particular, for applications executing on a common VM. Each application executing on the common VM is mapped to a cluster of banks designated for exclusive use by the mapped application, in comparison, for example, to the BPM method that consider the common VM as a single executing application. Methods such as BPM assign banks of DRAM to the common VM without consideration of the individual application executing on the common VM, which may lead to contention by the applications running on the common VM. The computational performance improvement is obtained in the host OS side and/or the guest OS side.

A brief discussion of other memory management methods is now provided, to help understand the technical problem addressed herein. To avoid contention in memory banks, physical addresses are distributed evenly over the whole available physical address range when implemented by other methods. In such implementations, the memory controller tries to maximize the DRAM utilization, but as a side affect it causes unpredictability for application performance. Applications are allowed to access all memory banks which lead to contention when several applications are accessing the same memory banks in parallel. Such a situation may occur, for example, with multiprocessor systems when several applications are executed in parallel. In such a case, the memory controller swaps in the relevant memory bank content for each application that is accessing the same memory bank. Changing memory bank content is a costly operation compared to the case when the same application accesses the same memory bank repeatedly, since new memory content is loaded on the bank for each application. In contrast, the systems, apparatus, and/or methods described herein reduce or prevent contention by mapping applications of a common VM to use different memory banks of the DRAM.

The BPM method cannot be implemented in a virtual environment. The BPM method considers the VM as a whole, and cannot identify and consider separate applications running on the VM. The BPM method is inoperable when a guest OS tries to use bank clustering (termed coloring when used in reference to the BPM method) for applications executed on the guest OS, since the memory controller works only with physical addresses whereas the VM uses guest physical addresses which are not understood by the memory controller. In practice, the guest physical addresses are a single process virtual address (also referred to as VA) space. The VM is treated as a single process, which effectively means that once the host OS launches a new VM (i.e., a new single process) and selects bank color for the process based on the BPM method then all applications running on the VM are mapped on same bank color regardless of the bank colors used by the guest OS.

Before explaining at least one embodiment of the disclosure in detail, it is to be understood that the disclosure is not necessarily limited in its application to the details of construction and the arrangement of the components and/or methods set forth in the following description and/or illustrated in the drawings and/or the Examples. The disclosure is capable of other embodiments or of being practiced or carried out in various ways.

The present disclosure may be a system, a method, and/or a computer program product. The computer program product may include a computer readable storage medium (or media) having computer readable program instructions thereon for causing a processor to carry out aspects of the present disclosure.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing.

Computer readable program instructions described herein can be downloaded to respective computing/processing devices from a computer readable storage medium or to an external computer or external storage device via a network, for example, the Internet, a local area network, a wide area network and/or a wireless network.

The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present disclosure.

Aspects of the present disclosure are described herein with reference to flowchart illustrations and/or block diagrams of methods, apparatus (systems), and computer program products according to embodiments of the disclosure. It will be understood that each block of the flowchart illustrations and/or block diagrams, and combinations of blocks in the flowchart illustrations and/or block diagrams, can be implemented by computer readable program instructions.

The flowchart and block diagrams in the Figures illustrate the architecture, functionality, and operation of possible implementations of systems, methods, and computer program products according to various embodiments of the present disclosure. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The BPM method is now described in additional detail as an aid in understanding the technical problem addressed by the systems, apparatus, and/or methods (e.g., code instructions stored in a data storage device executed by one or more processors) described herein. BPM uses a software (also referred to as SW) test program to determine used physical address bits in the memory controller and creates its own SW based model that exploits knowledge of the bank bits in order to allocate applications to exclusively use specified bank bits. In the BPM SW based model the memory pools in a buddy allocator are created such that each pool allocates memory pages only from specified memory banks as specified by the memory controller. When a new process is created with a new process identifier (ID), certain bank colors are assigned to it and stored into kernel process structures. When a page fault occurs the kernel identifies allocated bank colors from the process ID and provides the information to the buddy allocator which considers the assigned bank color bits when allocating physical memory pages for the process. When two applications are assigned to use different bank colors, the two applications cannot disturb each other's performance.

The BPM is designed for two or more applications executed by a standard OS. The BPM method is inoperable (or is inefficient) when the two or more applications run on a common VM. The systems, apparatus, and/or methods described herein address the technical problem of reducing or preventing DRAM memory contention between two or more applications running on a common VM, while providing efficient DRAM operation (e.g., preventing or reducing memory swaps by the memory controller).

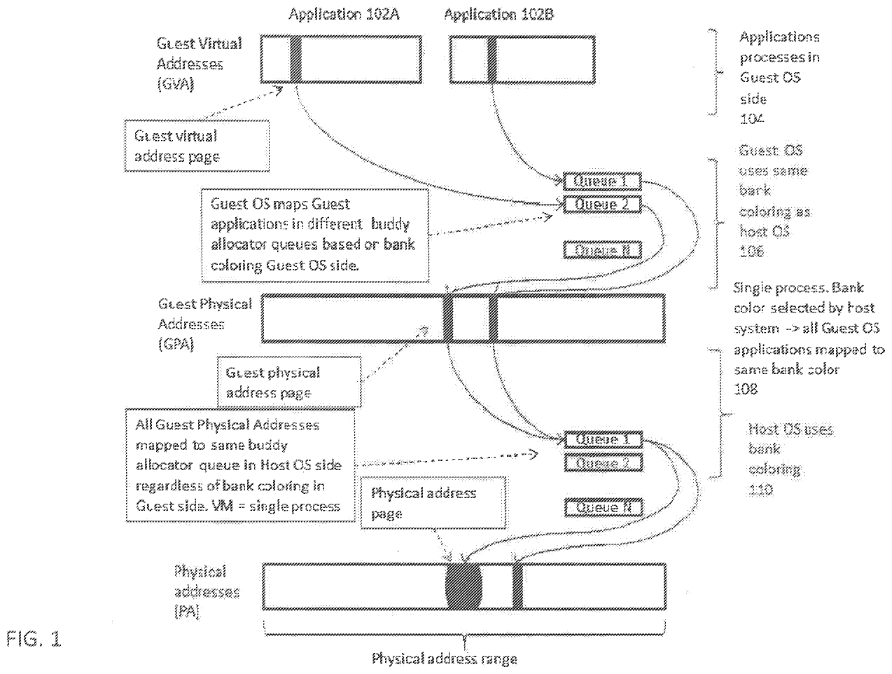

Reference is now made to FIG. 1, which is a schematic of dataflow in a computing system implementing the BPM method while running two applications on a common VM to help in understanding the addressed technical problem, in accordance with some embodiments of the present disclosure. The technical problem relates to the host OS being unaware that one or both host applications 102A-B are actually VM each running one or more of its own applications, since when BPM is implemented, for the host OS each VM is treated as a single application.

Applications 102A-B are running on a guest OS 104, which uses bank coloring for guest applications 102A-B. Guest OS 104 allocates guest physical pages in application page tables. At 106, the guest physical pages are selected based on coloring allocated for the guest application. Similarly, at 106, the Host OS uses bank coloring to allocate physical pages based on defined bank colors allocated to applications running on host system. At 108, guest OS applications 102A-B are mapped to a common bank color. As discussed, when BPM is implemented, the host OS is unaware that one or both host applications 102A-B are actually VM each running one or more of its own applications, since for the host OS each VM is treated as a single application. At 110, the physical memory controller maps pages on banks based on physical address bits and therefore the bank coloring for the VM applications is actually selected by the host OS and not by the Guest OS when BPM is implemented.

The systems, apparatus, and/or methods described herein address the above described technical problem by mapping applications running on a common VM to different memory banks. The mapping may be performed using a similar method to that of mapping applications running on the host OS, providing similar computations performance improvements. The computational performance improvements arise from reducing or preventing memory contention, and/or reducing or preventing memory controller swaps which is a computationally costly operation.

Additional details of the BPM method are now described. The BPM extends the LINUX buddy allocator to take bank colors into account. The kernel uses a buddy system to manage the free physical pages, which are organized as different orders (0˜11) of free lists. The BPM method modifies the original free list organization into a hierarchy, for each order of free page list, BPM re-organize the free pages to form 32 colored free lists according to the 5 bank bits. Each process has its own colors (i.e., a group of banks). When a page fault occurs, the OS kernel searches a colored free list and allocates a page for the process. The process is transparent to applications so that programmers do not necessarily need to modify programs. The basic operation of BPM is to read specified bits from physical address and use those bits to select the bank color.

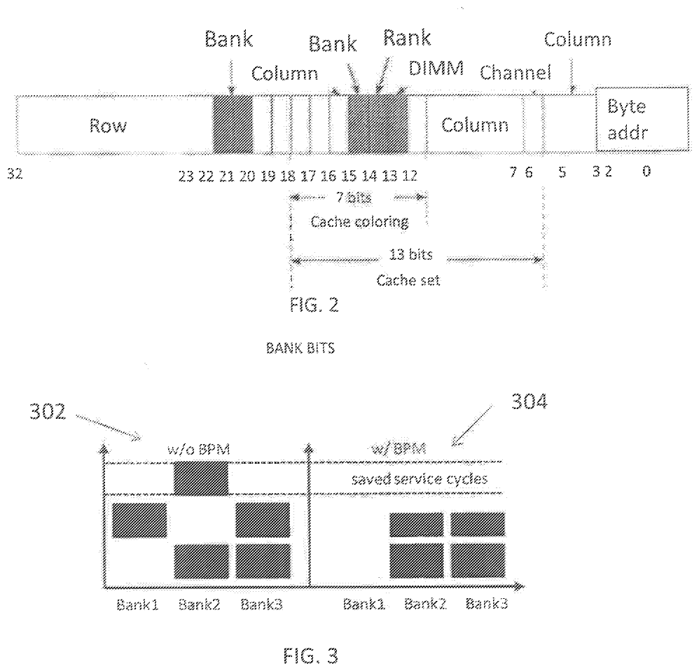

Reference is now made to FIG. 2, which is a schematic depicting an example of selection of bank bits by a memory controller to help in understanding the addressed technical problem, in accordance with some embodiments of the present disclosure. In general, bytes in DRAM are addressable by physical addresses which consist of, for example, 32-bits or 64-bits (depending on CPU architecture). From the memory controller point of view some of the physical address bits have special meaning. For example, bank selection is done only based on certain bits in physical address. As depicted in the example of FIG. 2, a memory controller uses bits 22-21 and 14 to select the bank. Address bit 15 is used to select the channel. Effectively, memory controller in the case of FIG. 2 supports 2\hat{ }3=8 banks and 2\hat{ }1=2 channels. The actual bit pattern to select banks, rows, and channels is dependent on the specific hardware configuration implementation.

Reference is now made to FIG. 3, which is a schematic depicting allocation of DRAM banks to applications by the BPM method, to help understand the addressed technical problem, in accordance with some embodiments of the present disclosure. Schematic 302 depicts memory pages from different applications (each application is represented by a color light grey, grey, and black) distributed to Bank 1, Bank 2, and Bank 3, using standard methods (i.e., without the BPM method). Each Bank is used by two different applications. Schematic 304 depicts assignment of each Bank to a single application based on the BPM method.

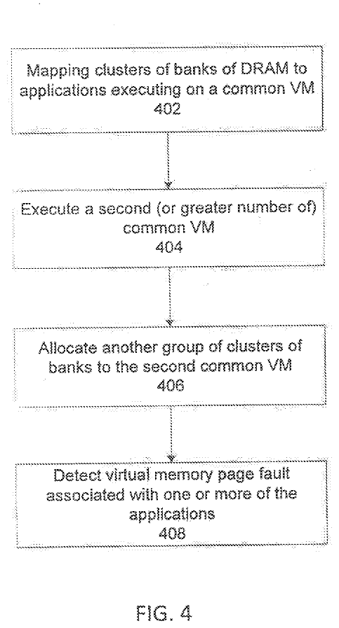

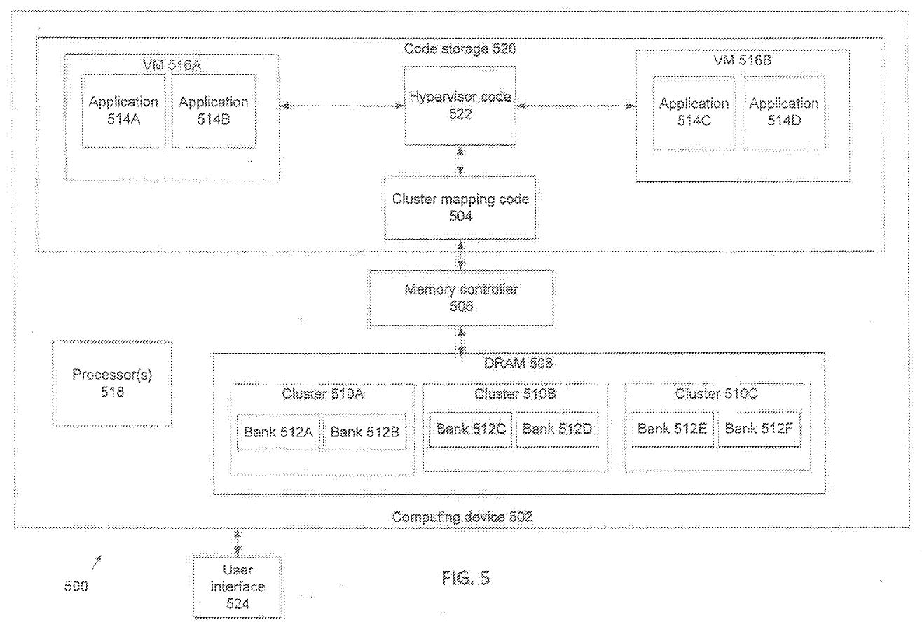

Reference is now made to FIG. 4, which is a flowchart of a method that manages DRAM by mapping clusters of banks of the DRAM to each application executing on a common VM, in accordance with some embodiments of the present disclosure. Reference is also made to FIG. 5, which is a block diagram of a system 500 that includes an apparatus implemented as a computing device 502 that stores cluster mapping code 504 that communicates with a memory controller 506 to manage DRAM 508, in accordance with some embodiments of the present disclosure. Cluster mapping code 504 maps clusters (e.g., two clusters 510A-B) of banks (e.g., four banks 512A-D) to each application (e.g., four applications 514A-D) executing on a common VM (e.g., two VM 516A-B). Cluster mapping code 504 implements the acts described with reference to FIG. 4 when executed by processor(s) 518 of computing device 502.

Computing device 502 may be implemented as, for example, one of more of a single computing device (e.g., client terminal), a group of computing devices arranged in parallel, a network server, a web server, a storage server, a local server, a remote server, a client terminal, a mobile device, a stationary device, a kiosk, a smartphone, a laptop, a tablet computer, a wearable computing device, a glasses computing device, a watch computing device, and a desktop computer.

Computing device 502 includes one or more processor(s) 518, implemented as for example, central processing unit(s) (CPU), graphics processing unit(s) (GPU), FPGA, digital signal processor(s) (DSP), application specific integrated circuit(s) (ASIC), customized circuit(s), processors for interfacing with other units, and/or specialized hardware accelerators. Processor(s) 518 may be implemented as a single processor, a multi-core processor, and/or a cluster of processors arranged for parallel processing (which may include homogenous and/or heterogeneous processor architectures). It is noted that processor(s) 518 may be designed to implement in hardware one or more features stored as cluster mapping code 504 (e.g., described herein as stored in a code storage 520).

Code storage 520 stores code instructions implementable by processor(s) 518. Code storage 520 is implemented as, for example, a random access memory (RAM), read-only memory (ROM), and/or a storage device, for example, non-volatile memory, magnetic media, semiconductor memory devices, hard drive, removable storage, and optical media (e.g., digital versatile disc (DVD), compact disc ROM (CD-ROM)).

Code storage 520 store hypervisor code 522 that runs one or more VM 516A-B. Each VM 516A-B may independently run one or more applications. For example, as shown VM 516A runs applications 514A-B, and VM 516B runs applications 514C-D.

Hypervisor code 522 communicates with cluster mapping code 504, for example, cluster mapping code 502 is implemented within hypervisor code 522 and/or is implemented as a library and/or function that is called by hypervisor code 522.

Cluster mapping code 504 communicates with a memory controller 506 that controls DRAM 508 to map clusters 510A-B of banks 512A-D, as described herein. Memory controller 506 may be implemented in hardware and/or software.

Computing device 502 may be in communication with a user interface 524 that presents data and/or includes a mechanism for entry of data, for example, one or more of a touch-screen, a display, a keyboard, a mouse, voice activated software, and a microphone. User interface 524 may be used to configure parameters of the cluster mapping code 504, and/or view performance of the cluster mapping code 504.

Referring now back to FIG. 4, the acts of the method described with reference to FIG. 4 are executed by cluster mapping code 504, which is accessed and/or integrated with hypervisor code 522, executed by processor(s) 518 of computing device 502. Cluster mapping code 504 may be transparent to the applications running on the hypervisor, such that programmers may program the applications without consideration of cluster mapping code 504.

At 402, processor(s) 518 executing cluster mapping code 504 maps each cluster (e.g., 510A-B) of banks (e.g., 512A-D) of DRAM 508 to each application (e.g., 514A-B) executing on a common VM (e.g., 516A) running on a host OS of a host computing device 502. Each cluster of banks is used exclusively by each mapped application. For example, application 514A is mapped to cluster 510A and exclusively uses banks 512A-B, and application 514B is mapped to cluster 510B and exclusively uses banks 512C-D.

Optionally, one or more applications are mapped to two or more clusters of banks of the DRAM. The two or more clusters of banks are used exclusively by the mapped application(s). For example, application 514A may be mapped to clusters 510A and 510B, which provides application 514A with exclusive use of banks 512A-D of clusters 510A-B. Applications requiring a large amount of memory may be mapped to two or more clusters, for example, rather than mapping to a single cluster, which improves computational performance by providing the application with sufficient memory rather than experiencing errors due to insufficient memory.

Processor(s) 518 executes a hypervisor (implemented as hypervisor code 522) that runs common VM 516A. The hypervisor perform the mapping of each cluster of banks of DRAM 508 by translating the mapping of the clusters of DRAM 508 to physical addresses that are provided to memory controller 506 controlling DRAM 508.

The mapping is performed using software, which provides for integration with an existing memory controller implemented in hardware. Mapping using software provides for rapid and easy deployment in existing computing devices.

Hypervisor 522 maps guest physical addresses used by the hypervisor to physical addresses of DRAM 508 controlled by memory controller 506. The absolute physical address at the host OS side is not typically the same as the guest physical addresses in the VM. The host OS may use second level page tables to map guest physical addresses to host physical addresses. When an addressing scheme uses the same bank cluster bits (also referred to herein as bank color bits), for example as shows in FIG. 2, the host OS and guest OS may use the same bank cluster bits. The VM may select the same location of bank cluster bits from the guest physical addresses as the host OS selects from actual physical addresses. Bank cluster selection as shown in FIG. 2 is based on a specific subset of the address bits, not the whole address. The used bank cluster bits may be communicated to the VM kernel, for example, using a defined kernel command line parameter bank-cluster-bits.

The mapping of clusters of banks to applications of the VM may be performed by a VM kernel. The mapping is performed according to a defined scheduling policy, for example, round robin, or an application hinting mechanism. The scheduling policy may be defined by a user (e.g., using user interface 524), and/or predefined (e.g., by an administrator and/or as a default setting of the software). The scheduling policy may be selected for the computational environment to further improve computational performance.

In order to limit available cluster for VM application, a defined kernel command line parameter bank-cluster-bits may be provided for the VM kernel. The VM kernel may allocate clusters to the applications based on the defined scheduling policy. Different VMs are allocated to different clusters in order to avoid applications from different VMs disturbing each other and/or causing memory contention.

The same location of bits indicative of the clusters of banks may be selected from the guest physical addresses used by the common VM that are used by the host OS from the actual physical addresses.

Optionally, the cluster mapping is denoted by the host and guest OS based on the bank coloring bits in the LINUX buddy allocator implemented by the BPM method.

VM 516A may be allocated with a maximum number of available clusters using an implemented bank-cluster-bits kernel command line parameter which sets the maximum number of memory banks available for the VM, which denotes the maximum number of applications that may be mapped on different memory banks of DRAM 508.

At 404, hypervisor code 522 may execute a second (or greater number of) common VM 516B, which runs one or more applications (e.g., 514C-D).

It is noted that the host OS is instructed to allocate two or more clusters to each executing VM 516A-B. The two or more designated clusters provide for execution of two or more applications on each VM, where each application is allocated at least one cluster for exclusive use.

Two exemplary control mechanisms may be used for controlling the VM's 516A cluster usage. A first control mechanism is used to provide the guest kernel with the maximum number of clusters to use for the running application. A second control mechanism is used in the hypervisor side in order to enforce and limit cluster usage of the VM. The control mechanisms may be implemented as follows.

Bank-cluster-bits guest kernel command line parameter: Instructs the guest kernel what cluster queues the buddy allocators should use inside the VM for the applications. These are clusters that the hypervisor enforces and/or supports for the respective VM. When the VM decides to use another cluster than the specified bank-cluster-bits (for example, due to a kernel bug), the hypervisor is instructed to select a default cluster queue for the faulting guest physical address.

Clusters: The guest OS is provided with the assigned clusters, optionally using a defined bank-cluster-bits kernel command line parameter. In Qemu the bank-cluster-bits command line parameter is provided as an extension to the—append Qemu option. The option in Qemu instructs the clusters allocated for the whole VM, and is communicated via a IOTCL BANK_COLOR call to KVM hypervisor. KVM stores cluster information to KVM struck which includes also VM ID information.

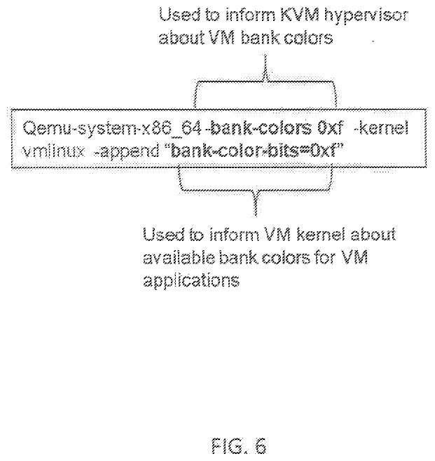

Reference is now made to FIG. 6, which is a schematic depicting the described Qemu/KVM command line options, in accordance with some embodiments of the present disclosure.

The defined Qemu option bank-clusters sets the upper bound for the overall memory banks available for all the applications that run on each VM. Applications running on each VM cannot be assigned more memory banks than the value set by the upper bound to the VM.

At 406, another group of clusters banks of the DRAM 508 is allocated to second VM 516B running on the host OS of the host computing device 502. Different VM are allocated to different clusters, such that memory contentions between applications running on different VM is reduced or prevented. For example, the group of clusters 510B-C are allocated to second VM 516B, with cluster 510A allocated to the first VM 516A. Each VM may independently perform mapping of its assigned clusters to the applications running on the respective VM, which improves overall memory performance and/or computational performance.

The second VM 516B maps each member of the group of clusters 510B-C to the applications executing on the second VM 516B. Each member of the group of clusters defines banks of the DRAM for exclusive use by each mapped application executing on the second VM 516B. For example, cluster 510B (i.e., banks 512C-D) is mapped to application 514C running on second VM 516B, and clusters 510C (i.e., banks 512E-F) is mapped to application 514D running on second VM 516B.

Clusters of banks of the DRAM are uniquely mapped to each application executing on each VM running on the host OS of the host computing device. Each application executing on each VM has exclusive use of the mapped cluster. The unique assignment of clusters to each application of each VM prevents or reduces memory contention between applications of the same VM and applications of different VM.

When multiple VMs are executed by a common host computing device, applications from different VMs are set to use different clusters. Each VM is set with non-overlapping bank cluster bits, for example, using a defined Guest OS kernel command line parameter (e.g., bank-cluster-bits) and Qemu bank-clusters—option.

The hypervisor 522 includes code to support designation of different clusters of banks 510A-C to different applications running on each VM 516A-B, which may be implemented as described in the following exemplary implementation In the VM creation phase, the defined Qemu bank-clusters denotes the available clusters of banks for the VM process considered in its entirety (that includes applications running on the VM). The available clusters of banks are provided to the KVM hypervisor using a defined IOCTL BANK_CLUSTER call. The hypervisor stores the bank cluster data in a KVM struct or in VCPU struct for the threads.

At 408, a virtual memory page fault associated with a certain application (e.g., 514A or 514B) executing on common VM 516A is handled.

Based on the above described exemplary implementation, in case of page fault due to the guest physical address the second level page fault handler at first reads VM ID in order to associate the faulting VM to the associated KVM struct. Depending on the processor architecture, the VM IS may be read from VTTRB register. The obtained VM ID may be used against the KVM/VCPU struct which also includes the VM ID to check the cluster bits for the VM.

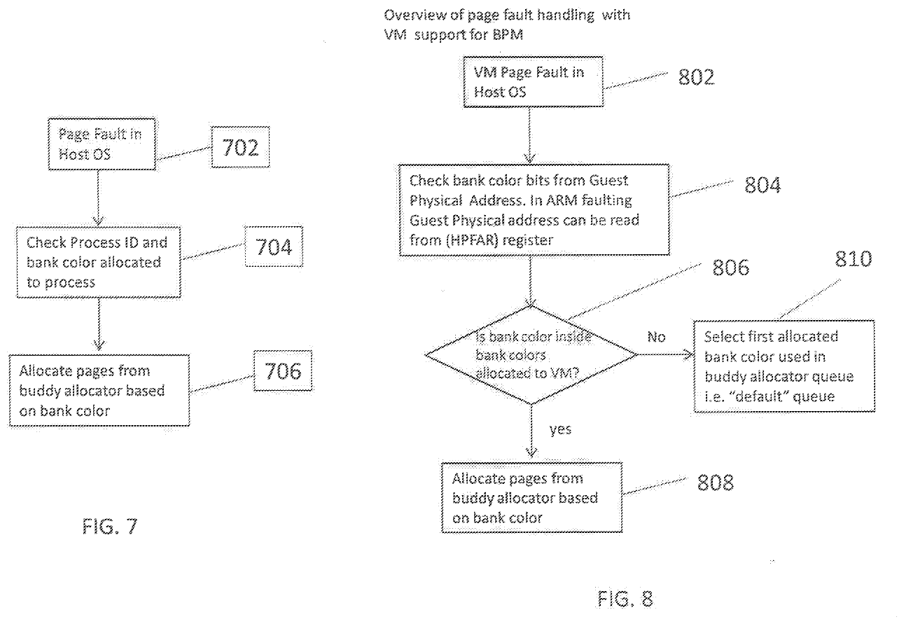

Reference is now made to FIG. 7, which is a flowchart depicting page fault handing using other methods that do not consider applications executing on a VM, for example, the BPM method to help understand implementations of the present disclosure.

At 702, a page fault is detected by the host OS. The page fault occurs when a process attempts to allocate more memory than the host OS allocated to the process using bank colors, for example, from the process structure such as process task-struct.

At 704, the process ID and bank color allocated to the process is checked.

At 706, the process ID and bank color are provided to the buddy allocator for allocation of memory pages from the allocated bank queues based on bank color. When other methods (e.g., BPM method) are implemented, the second level page fault handler requests a page from the buddy allocator without a specific policy. The buddy allocator simply returns the first available page with the right size from the freelist.

Reference is now made to FIG. 8, which is a flowchart depicting page fault handling by computing device 502, which takes into account applications running on VMs, in accordance with some embodiments of the present disclosure. The host OS includes code instructions for selection of clusters from the guest physical addresses after a second level page fault is detected. Clusters selected at the VM side are enforceable at the hypervisor side. Cluster selection is performed at the VM side using clusters assigned to the application, which allows the hypervisor side to figure out the desired cluster from the faulting guest physical address and associated cluster bits.

At 802, a virtual memory page fault associated with a certain application (e.g., 514A or 514B) executing on common VM 516A, is detected by the host OS of computing device 502. The application running on the VM causes the page fault by accessing a certain guest physical address that does not have a mapping to an actual physical address in second level page tables for the VM.

At 804, the cluster of banks mapped to the certain application associated with the virtual memory page fault is identified. The cluster of banks mapped to the certain application is identified by checking the bits indicative of the cluster of banks in the guest physical address.

The cluster of banks mapped to the certain application may be identified by checking the Faulting Guest Physical Address Register, for example, HPFAR register, CR2 register, and/or CR3 register. The bits of the guest physical address and/or the registers may be accessed by the hypervisor to determine the guest physical address and associated cluster.

At 806, an evaluation is performed to determine whether there are sufficient banks remaining within the cluster allocated to the VM running the certain application that caused the virtual memory page fault.

Alternatively or additionally, the evaluation determines when an invalid cluster of banks is identified as mapped to the certain application.

At 808, the evaluation determines that there are sufficient banks remaining, and/or that the cluster of banks mapped to the certain application is valid. At least one additional physical memory page is allocated to the certain application from the mapped cluster of banks.

Alternatively, at 810, there are insufficient banks remaining and/or the cluster of banks mapped to the certain application is invalid. At least one additional virtual memory page is allocated to the certain application from default clusters of banks allocated to the common VM. For example, the host OS directs the applications to a default buddy allocator queue selected by the host OS kernel for the VM.

The following is an exemplary code from Palloc framework for selecting pages based on bank bits. The pseudocode below implements the flowchart depicted in FIG. 8:

```
        static inline int page_to_color(struct page *page)
        {
            int bank_color = 0;
            int idx = 0;
            int c;
            unsigned long paddr = page_to_phys(page);
            for_each_set_bit(c, &sysctl_palloc_mask,
            sizeof(unsigned long) * 8) {
                if (use_mc_xor) {
                        if (((paddr >> c) & 0x1) \hat{ }((paddr >>
                        mc_xor_bits[c]) & 0x1))
                                bank_color |= (1<<idx);
                } else {
                        if ((paddr >> c) & 0x1)
                                bank_color |= (1<<idx);
                }
                idx++;
            }
            return bank_color;
        }
        If bank_color = {allocated VM colors} then get pages from
buddy allocator here buddy allocator color = bank_color; and
        If bank_color ∉ {allocated VM colors} then get pages from
buddy allocator here buddy allocator color = DEFAULT_COLOR.
```

In the Palloc algorithm above the user defines sysctl_palloc_mask—bitmask which is used to select pages that match with the given mask. The use_mc_xor—flag is used to indicate whether memory controller uses xor method to select bank bits from the physical address.

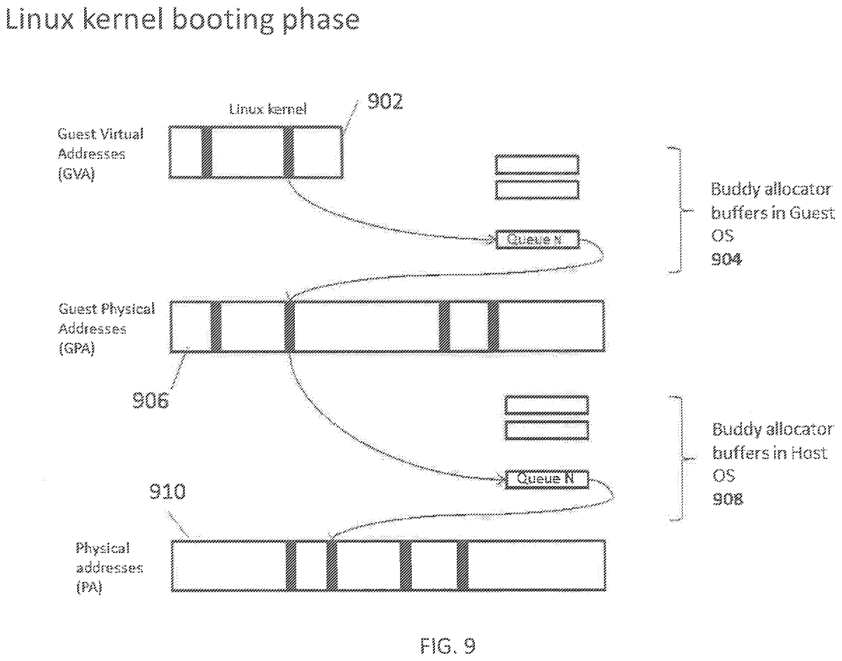

Reference is now made to FIG. 9, which is a schematic depicting an exemplary mapping between guest virtual addresses and physical addresses during a LINUX kernel booting phase, in accordance with some embodiments of the present disclosure. Guest virtual addresses of a LINUX kernel 902 are placed in a buddy allocator that allocates buffers 904 of the guest OS. Each buffer 904 maps to a guest physical address 906. The guest physical addresses 906 map to a buddy allocator that allocates buffers 908 of the Host OS. Each buffer 908 maps to physical address(es) 910.

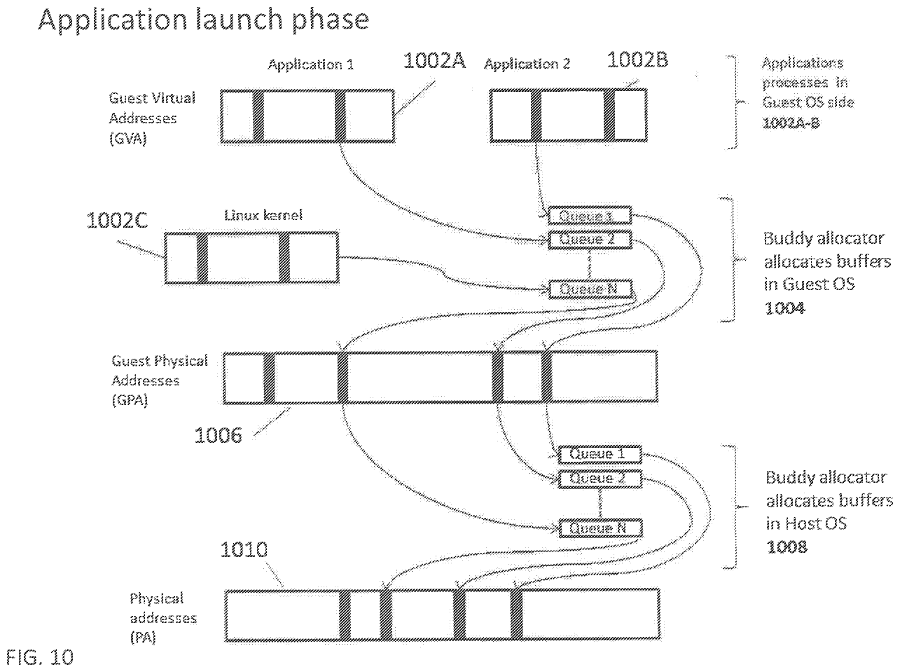

Reference is now made to FIG. 10, which is a schematic depicting an exemplary mapping between guest virtual addresses of a guest virtual address page and physical addresses during an application launch phase, in accordance with some embodiments of the present disclosure. The guest physical addresses of a guest physical address page of applications 1002A-B and LINUX kernel 1002C, which are running on a common VM, are placed in respective queues 1004 of a buddy allocator that allocates buffers in the guest OS. Each queue 1004 is mapped to a respective guest physical address 1006. The Guest OS maps guest applications 1002A-B of different buddy allocator queues 1004 based on clustering assigned to the guest OS side. The guest physical addresses 1006 are placed in respective buffers 1008 of a buddy allocator that allocates buffers 1008 of the host OS. Each buffer 1008 is mapped to a respective physical address 1010.

Other systems, methods, features, and advantages of the present disclosure will be or become apparent to one with skill in the art upon examination of the following drawings and detailed description. It is intended that all such additional systems, methods, features, and advantages be included within this description, be within the scope of the present disclosure, and be protected by the accompanying claims.

The descriptions of the various embodiments of the present disclosure have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

It is expected that during the life of a patent maturing from this application many relevant DRAM, memory controller, and VMs will be developed and the scope of the terms DRAM, memory controller, and VM are intended to include all such new technologies a priori.

As used herein the term “about” refers to ±10%.

The terms “comprises”, “comprising”, “includes”, “including”, “having” and their conjugates mean “including but not limited to”. This term encompasses the terms “consisting of” and “consisting essentially of”.

The phrase “consisting essentially of” means that the composition or method may include additional ingredients and/or steps, but only if the additional ingredients and/or steps do not materially alter the basic and novel characteristics of the claimed composition or method.

As used herein, the singular form “a”, “an” and “the” include plural references unless the context clearly dictates otherwise. For example, the term “a compound” or “at least one compound” may include a plurality of compounds, including mixtures thereof.

The word “exemplary” is used herein to mean “serving as an example, instance or illustration”. Any embodiment described as “exemplary” is not necessarily to be construed as preferred or advantageous over other embodiments and/or to exclude the incorporation of features from other embodiments.

The word “optionally” is used herein to mean “is provided in some embodiments and not provided in other embodiments”. Any particular embodiment of the disclosure may include a plurality of “optional” features unless such features conflict.

Throughout this application, various embodiments of this disclosure may be presented in a range format. It should be understood that the description in range format is merely for convenience and brevity and should not be construed as an inflexible limitation on the scope of the disclosure. Accordingly, the description of a range should be considered to have disclosed all the possible subranges as well as individual numerical values within that range. For example, description of a range such as from 1 to 6 should be considered to have disclosed subranges such as from 1 to 3, from 1 to 4, from 1 to 5, from 2 to 4, from 2 to 6, from 3 to 6 etc., as well as individual numbers within that range, for example, 1, 2, 3, 4, 5, and 6. This applies regardless of the breadth of the range.

Whenever a numerical range is indicated herein, it is meant to include any cited numeral (fractional or integral) within the indicated range. The phrases “ranging/ranges between” a first indicate number and a second indicate number and “ranging/ranges from” a first indicate number “to” a second indicate number are used herein interchangeably and are meant to include the first and second indicated numbers and all the fractional and integral numerals therebetween.

It is appreciated that certain features of the disclosure, which are, for clarity, described in the context of separate embodiments, may also be provided in combination in a single embodiment. Conversely, various features of the disclosure, which are, for brevity, described in the context of a single embodiment, may also be provided separately or in any suitable subcombination or as suitable in any other described embodiment of the disclosure. Certain features described in the context of various embodiments are not to be considered essential features of those embodiments, unless the embodiment is inoperative without those elements.

1. An apparatus for managing a dynamic random access memory (DRAM), comprising:
a DRAM comprising a plurality of clusters of banks, wherein each of the clusters comprise at least one bank;
a memory configured to store instructions; and
a processor coupled to the memory, wherein the instructions cause the processor to be configured to:
identify a plurality of applications that are executing on a common virtual machine (VM), wherein the common VM runs on a host operating system (OS) of a host computing device; and
map a first cluster of the clusters to a first application of the applications, wherein the DRAM comprises the first cluster, and wherein all first banks in the first cluster is exclusively used by the first application.

2. The apparatus of claim 1, wherein the instructions further cause the processor to execute a hypervisor that is configured to:
run the common VM;
translate mapping of clusters of banks to first physical addresses;
provide a translated mapping of the clusters to a memory controller, wherein the memory controller controls the DRAM; and
perform, based on the translated mapping, the mapping of the clusters.

3. The apparatus of claim 2, wherein the hypervisor is further configured to map guest physical addresses used by the hypervisor to second physical addresses of the DRAM.

4. The apparatus of claim 1, wherein the instructions further cause the processor to be configured to allocate a second cluster of the clusters to a second VM that runs on the host OS, wherein the second clusters comprise a plurality of second banks of the DRAM, wherein the second VM is configured to map the second cluster to a corresponding application of a plurality of second applications executing on the second VM, and wherein each member of the second clusters defines the second banks of the DRAM for exclusive use by each corresponding mapped application of the second applications.

5. The apparatus of claim 1, wherein the instructions further cause the processor to be configured to uniquely map a third cluster of the clusters of banks to a plurality of third applications, wherein the third applications are executing on a plurality of VMs running on the host OS, and wherein each of the third applications has exclusive use of a corresponding mapped third cluster.

6. The apparatus of claim 1, wherein the instructions further cause the processor to be configured to map the first cluster to the first application according to a scheduling policy.

7. The apparatus of claim 1, wherein the instructions further cause the processor to be configured to select same locations of bits of the guest physical addresses from actual physical addresses, wherein the same location of bits are indicative of the clusters of banks, and wherein the guest physical addresses are used by the common VM.

8. The apparatus of claim 1, wherein the instructions further cause the processor to be configured to:
detect, using the host OS, a virtual memory page fault associated with a certain application of the applications;
identify a fourth cluster of the clusters of banks mapped to the certain application; and
allocate at least one additional physical memory page to the certain application from the fourth cluster.

9. The apparatus of claim 8, wherein the instructions further cause the processor to be configured to:
identify that an invalid cluster is mapped to the certain application; and
allocate at least one additional virtual memory page to the certain application from one of a plurality of default clusters allocated to the common VM.

10. The apparatus of claim 8, wherein the instructions further cause the processor to be configured to:
check bits indicative of the fourth cluster in a guest physical address; and
identify the fourth cluster based on checking the bits.

11. The apparatus of claim 8, wherein the instructions further cause the processor to be configured to:
check a hyp prefetch fault address register (HPFAR) register; and
identify the fourth cluster based on checking the HPFAR.

12. The apparatus of claim 1 wherein at least one of the first applications is mapped to the first clusters, and wherein the first clusters are used exclusively by the at least one of the first applications.

13. A method of managing dynamic random access memory (DRAM), comprising:
identifying a plurality of applications that are executing on a common virtual machine (VM), wherein the common VM runs on a host operating system (OS) of a host computing device; and
mapping a first cluster of a plurality of clusters of banks of the DRAM to a first application of the applications, wherein each of the clusters of comprise a plurality of banks of the DRAM, and wherein all first banks in the first cluster are exclusively used by the first application.

14. The method of claim 13, further comprising mapping guest physical addresses used by a hypervisor to physical addresses of the DRAM, wherein the hypervisor hosts the common VM, and wherein the memory controller controls the DRAM.

15. The method of claim 14, further comprising:
detecting, using the host OS, a virtual memory page fault associated with a certain application of the applications;
identifying a second cluster of the clusters that is mapped to the certain application; and
allocating at least one additional physical memory page to the certain application from the second cluster.

16. The method of claim 15, further comprising:
identifying that an invalid cluster is mapped to the certain application; and
allocating at least one additional virtual memory page to the certain application from one of a plurality of default clusters allocated to the common VM.

17. The apparatus of claim 8, wherein the instructions further cause the processor to be configured to check a CR2 register to identify the fourth cluster.

18. The apparatus of claim 8, wherein the instructions further cause the processor to be configured to check a CR3 register to identify the fourth cluster.

19. The apparatus of claim 6, wherein the scheduling policy is a round robin scheduling policy.

20. The apparatus of claim 6, wherein the scheduling policy is an application hinting mechanism.
